(19) United States
(12) Patent Application Publication
(10) Pub. No.: US 2023/0275936 A1
(43) Pub. Date: Aug. 31, 2023

(54) IMS SUPPORT FOR NON-IMSI BASED SUPI WHEN THERE IS NO ISIM

(71) Applicant: Telefonaktiebolaget LM Ericsson (publ), Stockholm (SE)

(72) Inventors: George Foti, Dollard des Ormeaux (CA); Sorin Surdila, Laval (CA)

(21) Appl. No.: 18/017,869

(22) PCT Filed: Jul. 15, 2021
(86) PCT No.: PCT/IB2021/056398

§ 371 Date: Jan. 25, 2023

Related U.S. Application Data
(60) Provisional application No. 63/058,771, filed on Jul. 30, 2020.

(51) Int. Cl. H04L 65/1073; H04L 65/1016; H04W 8/26

(52) U.S. Cl. CPC H04L 65/1073; H04L 65/1016; H04W 8/26; H04W 80/04

(57) ABSTRACT

Systems and methods are disclosed herein for Internet Protocol (IP) Multimedia Subsystem (IMS) support for non-International Mobile Subscriber Identity (IMSI) based Subscription Permanent Identifier (SUPI). In one embodiment, a method performed by a wireless communication device for IMS registration comprises deriving IMS registration information based on a non-IMSI based SUPI of the wireless communication device and sending an IMS registration request to an IMS node, the IMS registration request comprising the IMS registration information. In this manner, the non-IMSI SUPI can be reused for IMS access, e.g., when the network administrator does not plan to use an IP Multimedia Services Identity Module (ISIM), IMS Credential (IMC), or any future IMS-specific identity module in the deployed wireless communication devices. This simplifies the deployment by eliminating the need to manage and provision the IMS identity modules for a large number of wireless communication devices in use.

### RELATED APPLICATIONS

This application claims the benefit of provisional patent application Ser. No. 63/058,771, filed Jul. 30, 2020, the disclosure of which is hereby incorporated herein by reference in its entirety.

### TECHNICAL FIELD

The present disclosure relates to non-International Mobile Subscriber Identity (IMSI) based Internet Protocol (IP) Multimedia Subsystem (IMS) registration.

### BACKGROUND

Subscription Permanent Identifier (SUPI) is a Fifth Generation (5G) identity which generally can be International Mobile Subscriber Identity (IMSI) based or non-IMSI based. As of today, the only format specified for the non-IMSI SUPI is the Network Access Identifier (NAI). The NAI format is a Request For Comments (RFC) 4282 based user identification, as defined in Third Generation Partnership Project (3GPP) Technical Specification (TS) 23.003 (see, e.g., V16.3.0) for non-3GPP Radio Access Technology (RAT).

Support for registering identities using IMSI is already supported in Internet Protocol (IP) Multimedia Subsystem (IMS). This is based on a Universal Integrated Circuit Card (UICC) being present in the User Equipment (UE). If an IP Multimedia Services Identity Module (ISIM) or IMS Credential (IMC) is present in the UE (e.g., in the UICC), the ISIM or IMC includes the home operator domain name, a private identity (i.e., an IP Multimedia Private Identity (IMPI)), and one or more public identities (i.e., one or more IP Multimedia Public Identities (IMPUs)). In case no ISIM or IMC are available in the UE, 3GPP defines procedures on how to derive the home operator domain name and the private and public identities to be used by the UE for initial IMS registration from the IMSI.

### SUMMARY

Systems and methods are disclosed herein for Internet Protocol (IP) Multimedia Subsystem (IMS) support for non-International Mobile Subscriber Identity (IMSI) based Subscription Permanent Identifier (SUPI). In one embodiment, a method performed by a wireless communication device for IMS registration comprises deriving IMS registration information based on a non-IMSI based SUPI of the wireless communication device and sending an IMS registration request to an IMS node, the IMS registration request comprising the IMS registration information. In this manner, the non-IMSI SUPI can be reused for IMS access, e.g., when the network administrator does not plan to use an IP Multimedia Services Identity Module (ISIM), IMS Credential (IMC), or any future IMS-specific identity module in the deployed wireless communication devices. This simplifies the deployment by eliminating the need to manage and provision the IMS identity modules for a large number of wireless communication devices in use.

In one embodiment, the non-IMSI based SUPI of the wireless communication device is a Network Access Identifier (NAI) of the wireless communication device.

In one embodiment, an ISIM or IMC is not present in the wireless communication device.

In one embodiment, the IMS registration information comprises a private user identity, a public user identity, and a home operator domain name. In one embodiment, the private user identity is an IP Multimedia Private Identity (IMPI). In one embodiment, the public user identity is an IP Multimedia Public Identity (IMPU).

In one embodiment, deriving the IMS registration information comprises deriving the IMS registration information such that the home operator domain name is a first string appended with a domain portion of the non-IMSI based SUPI. In one embodiment, the first string is “ims.”. In one embodiment, deriving the IMS registration information comprises deriving the IMS registration information such that the private user identity comprises a username and a domain portion, wherein the username is a username comprised in the non-IMSI based SUPI and the domain portion is a first string appended with a domain portion of the non-IMSI based SUPI. In one embodiment, the first string is “ims.”.

In one embodiment, deriving the IMS registration information comprises deriving the IMS registration information such that the public user identity is a second string appended with a username and a domain portion, wherein the username is a username comprised in the non-IMSI based SUPI and the domain portion is a first string appended with a domain portion of the non-IMSI based SUPI. In one embodiment, the first string is “ims.” and the second string is “sip:”.

In one embodiment, both an ISIM and IMC are absent at the wireless communication device.

In one embodiment, sending the IMS registration request comprises sending the IMS registration request via a Fifth Generation (5G) system.

Corresponding embodiments of a wireless communication device are also disclosed. In one embodiment, a wireless communication device for IMS registration is adapted to derive IMS registration information based on a non-IMSI based SUPI of the wireless communication device and send an IMS registration request to an IMS node, the IMS registration request comprising the IMS registration information.

In one embodiment, a wireless communication device for IMS registration comprising one or more transmitters and processing circuitry associated to the one or more transmitters. The processing circuitry is configured to cause the wireless communication device to derive IMS registration information based on a non-IMSI based SUPI of the wireless communication device and send an IMS registration request to an IMS node, the IMS registration request comprising the IMS registration information.

Embodiments of a non-transitory computer readable medium are disclosed herein. In one embodiment, a non-transitory computer readable medium storing instructions executable by processing circuitry of a wireless communication device whereby the wireless communication device is operable to derive IMS registration information based on a non-IMSI based SUPI of the wireless communication device and send an IMS registration request to an IMS node, the IMS registration request comprising the IMS registration information.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a wireless communication system in which embodiments of the present disclosure may be implemented;

FIGS. 2 and 3 illustrate two specific examples of the wireless communication system of FIG. 1 in which the Third Generation Partnership Project (3GPP) core network is a Fifth Generation Core (5GC) and an Evolved Packet Core (EPC), respectively;

FIG. 4 illustrates an Internet Protocol (IP) Multimedia Subsystem (IMS) registration procedure in accordance with an embodiment of the present disclosure;

FIGS. 5, 6, and 7 are schematic block diagrams of example embodiments of an IMS node in which one or more aspects related to the present disclosure may be implemented; and

FIGS. 8 and 9 are schematic block diagrams of a wireless communication device (e.g., a User Equipment (UE)) in which one or more aspects related to the present disclosure may be implemented.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

IMS Node: As used herein, an “IMS node” is a node that implements all or part of the functionality of an Internet Protocol (IP) Multimedia Subsystem (IMS) entity such as, e.g., Proxy Call Session Control Function (P-CSCF), an Interrogating Call Session Control Function (I-CSCF), a Serving Call Session Control Function (S-CSCF), an Access Transfer Control Function (ATCF), an Access Gateway (AGW), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

There currently exist certain challenge(s). With the introduction of 5G for Enterprise deployments (e.g., Standalone Non-Public Networks (SNPSs)), it is expected that the use of a non-International Mobile Subscriber Identity (IMSI) based Subscription Permanent Identifier (SUPI) to greatly increase. Moreover, there is a strong incentive to re-use the 5G SUPI for accessing the Internet Protocol (IP) Multimedia Subsystem (IMS), e.g., in order to simplify UE and Home Subscriber Server (HSS) provisioning. For these deployments, there is a need to specify UE procedures on how to derive the IMS registration information (e.g., the home operator domain name and the private and public identities for IMS registration) in case the UE does not have an Internet Protocol Multimedia Services Identity Module (ISIM)/IMS Credential (IMC).

Certain aspects of the present disclosure and their embodiments may provide solutions to the aforementioned or other challenges. The present disclosure provides support in the IMS for deriving the IMS registration information (e.g., the home operator domain name and the private and public identities for IMS registration) from a non-IMSI based SUPI (e.g., a Network Access Identifier (NAI)), in case the UE is not equipped with an ISIM or an IMC. The IMS registration information derived from the non-IMSI based SUPI includes the home operator domain name, the private identity (e.g., the Internet Protocol Multimedia Private Identity (IMPI)), and the public identity (e.g., the Internet Protocol Multimedia Public Identity (IMPU)).

In one embodiment of the solution described herein:
the home operator domain name is the string “ims.” appended with the domain portion of the non-IMSI SUPI (e.g., the domain portion of the NAI in embodiments in which the non-IMSI SUPI is a NAI);
the private user identity (e.g., IMPI) is obtained as follows: the username is the same as the username in the non-IMSI SUPI (e.g., the username in the NAI in embodiments in which the non-IMSI SUPI is a NAI), and the domain portion is identical with the home operator domain name above; and
the public user identity (e.g., IMPU) is the string “sip:” appended with a username and domain portion equal to the non-IMSI SUPI derived private user identity above.
   Note that while the string “ims.” is used in the home operator domain name in the example embodiments described herein, other strings may alternatively be used. Likewise, while the string “sip:” is used in the public user identity in the example embodiments described herein, other strings may alternatively be used.

In the state of the art, when the IMPU is derived from an IMSI, it strongly recommended to block this IMPU for traffic. In other words, the UE shall not be able to initiate/receive calls on the IMSI-derived identity. When the derivation is done from a non-IMSI SUPI, the derived IMPU can be a valid identity to use for traffic (e.g., sip: alice@EnterpriseX.ca). Therefore, in one embodiment, the operator is provided with the possibility to configure whether or not to block the derived IMPU for traffic.

Certain embodiments may provide one or more of the following technical advantage(s). Embodiments of the solution allow the reuse of 5GC non-IMSI SUPI for IMS access when the network administrator does not plan to use ISIM, IMC, or any future IMS-specific identity module in the deployed devices. This simplifies the deployment by eliminating the need to manage and provision the IMS identity modules for the large number of UEs in use.

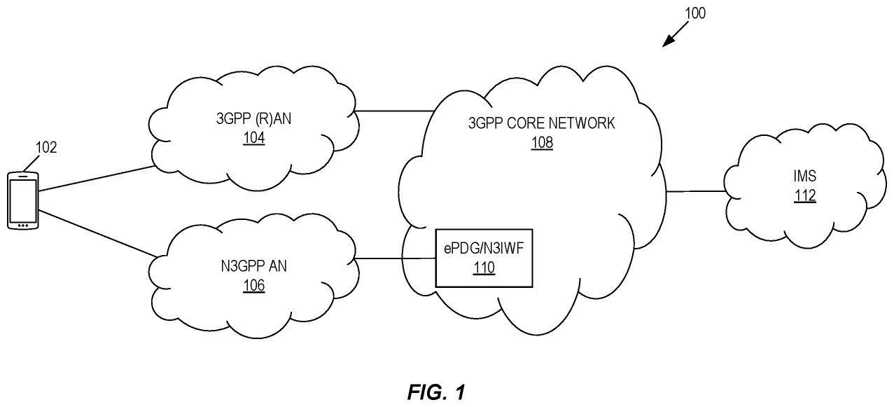

In this regard, FIG. 1 illustrates one example of a wireless communication system 100 in which a UE 102 has the capability to utilize either or both of a cellular access network, which is shown as a 3GPP (Radio) Access Network ((R)AN) 104, and a Wireless Local Area Network (WLAN) access network, which is shown as a Non-3GPP (N3GPP) AN 106. The 3GPP (R)AN 104 may be a Fourth Generation (4G) RAN (e.g., an LTE or LTE-Advanced RAN, including a number of base stations which are referred to as eNBs) or a 5G RAN (e.g., a NR RAN, including a number of base stations which are referred to as gNBs). The 3GPP (R)AN 104 is connected to a core network, which is shown as a 3GPP core network 108 (e.g., an Evolved Packet Core (EPC) or 5G Core (5GC)). The N3GPP AN 106 is connected to the 3GPP core network 108 via a gateway or interworking function, which is shown as an evolved Packet Data Gateway (ePDG)/N3GPP Inter-Working Function (N3IWF) 110. Notably, the term “ePDG” is used for 4G, and the term “N3IWF” is used for 5G. The 3GPP core network 108 is connected to an Internet Protocol (IP) Multimedia Subsystem (IMS) 112, as will be appreciated by one of skill in the art.

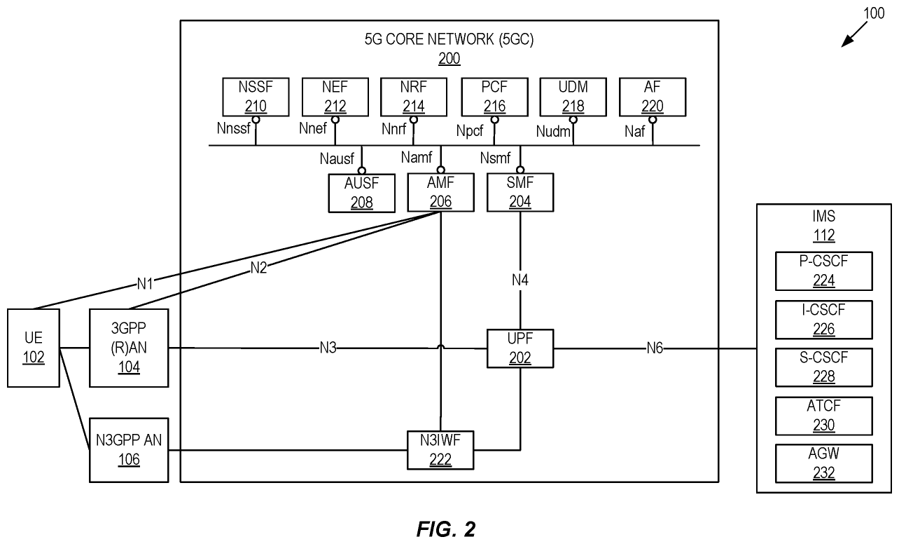

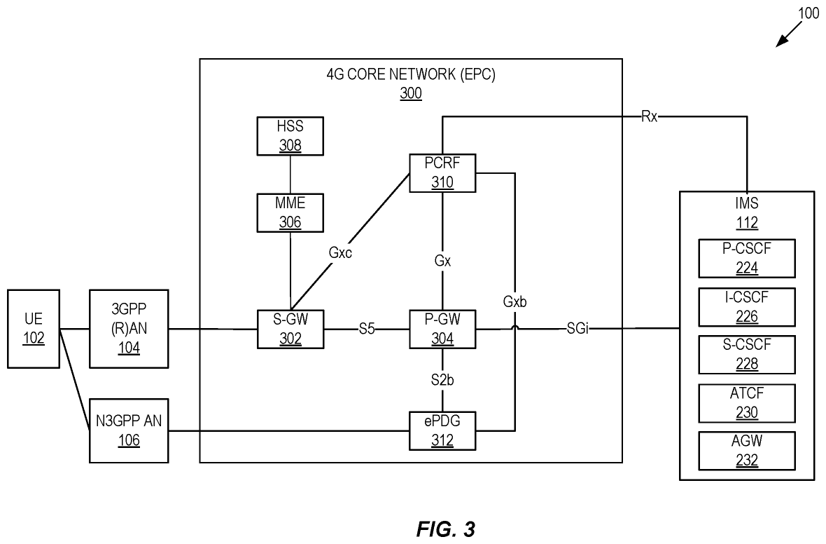

FIGS. 2 and 3 illustrate two specific examples of the wireless communication system 100 of FIG. 1 in which the 3GPP core network 108 is a 5GC 200 in FIG. 2 and an EPC 300 in FIG. 3.

Looking first at FIG. 2, as will be appreciated by one of skill in the art, the 5GC 200 includes a number of Network Functions (NFs) connected by service-based interfaces in the control plane. An NF may be implemented either as a network element on a dedicated hardware, as a software instance running on a dedicated hardware, or as a virtualized function instantiated on an appropriate platform, e.g., a cloud infrastructure. As illustrated, the 5GC 200 includes a UPF 202, an SMF 204, an AMF 206, an AUSF 208, a NSSF 210, a NEF 212, a NRF 214, a PCF 216, a UDM 218, and an Application Function (AF) 220.

Note that while FIG. 2 illustrates the 5GC 200 as a service-based architecture, a reference point representation may alternatively be used. Reference point representations of the 5G network architecture are used to develop detailed call flows in the normative standardization.

The 5GC 200 aims at separating a user plane and a control plane. The user plane carries user traffic while the control plane carries signaling in the network. In FIG. 2, the UPF 202 is in the user plane and all other NFs, i.e., the SMF 204, AMF 206, AUSF 208, NSSF 210, NEF 212, NRF 214, PCF 216, UDM 218, and AF 220, are in the control plane. Separating the user and control planes guarantees each plane resource to be scaled independently. It also allows UPFs 202 to be deployed separately from control plane functions in a distributed fashion. In this architecture, the UPFs 202 may be deployed very close to UEs 102 to shorten the Round Trip Time (RTT) between the UEs 102 and the data network for some applications requiring low latency.

The core 5G network architecture is composed of modularized functions. For example, the AMF 206 and SMF 204 are independent functions in the control plane. Separating the AMF 206 and SMF 204 allows for independent evolution and scaling. Other control plane functions like the PCF 216 and AUSF 208 can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as a service so that its reuse is possible. This service enables support for modularity. The user plane supports interactions such as forwarding operations between different UPFs 202.

The service(s) that an NF provides to other authorized NFs can be exposed to the authorized NFs through the service-based interface. In FIG. 2, the service-based interfaces are indicated by the letter “N” followed by the name of the NF (e.g., Namf for the service based interface of the AMF 206 and Nsmf for the service based interface of the SMF 204, etc.).

Some properties of the NFs shown in FIG. 2 may be described in the following manner; however, the interested reader can find additional details in 3GPP Technical Specification (TS) 23.501. The AMF 206 provides UE-based authentication, authorization, mobility management, etc. A UE 102 even using multiple access technologies is basically connected to a single AMF 206 because the AMF 206 is independent of the access technologies. The SMF 204 is responsible for session management and allocates IP addresses to UEs 102. It also selects and controls the UPF 202 for data transfer. If a UE 102 has multiple sessions, different SMFs 204 may be allocated to each session to manage them individually and possibly provide different functionalities per session. The AF 220 provides information on the packet flow to the PCF 216 responsible for policy control in order to support Quality of Service (QoS). Based on the information, the PCF 216 determines policies about mobility and session management to make the AMF 206 and SMF 204 operate properly. The AUSF 208 supports an authentication function for the UEs 102 or similar and thus stores data for authentication of the UEs 102 or similar while the UDM 218 stores subscription data of the UE 102.

In addition to the NFs described above, the 5GC 200 includes a N3IWF 222 that provides an interface between the N3GPP AN 106 and the 5GC 200. While not necessary for understanding the present disclosure, for additional details regarding the N3IWF 222, the interested reader is directed to 3GPP TS 23.501 and 23.502.

As will be understood by those of skill in the art, the IMS 112 includes various IMS entities such as, for example, a Proxy Call Session Control Function (P-CSCF) 224, an Interrogating Call Session Control Function (I-CSCF) 226, a Serving Call Session Control Function (S-CSCF) 228, an Access Transfer Control Function (ATCF) 230, and an Access Gateway (AGW) 232. The operational details of the P-CSCF 224, the I-CSCF 226, the S-CSCF 228, the ATCF 230, and the AGW 232 are well known to those of skill in the art and are therefore not described here.

Now turning to FIG. 3, as will be appreciated by one of skill in the art, the EPC 300 includes a number of core network entities such as, e.g., a Serving Gateway (S-GW) 302, a P-GW 304, an MME 306, a HSS 308, and a Policy and Charging Rules Function (PCRF) 310. The operational details of the S-GW 302, the P-GW 304, the MME 306, the HSS 308, and the PCRF 310 are well known to those of skill in the art and therefore are not repeated here.

In addition, the EPC 300 includes an ePDG 312 that provides an interface between the EPC 300 and the N3GPP AN 106. While not necessary for understanding the present disclosure, for additional details regarding the ePDG 312, the interested reader is directed to 3GPP TS 23.402.

Now, turning to embodiments of the present disclosure. In the embodiments described herein, one or more of the UEs 102 derive IMS registration information from respective non-IMSI based SUPIs (e.g., respective NAIs). The derived IMS registration information includes home operator domain name, private identity (e.g., IMPI), and public identity (e.g., IMPU) for IMS registration. In one embodiment, these UEs 102 are not equipped with an ISIM or IMC.

In one embodiment, such a UE 102 derives the IMS registration information as follows:
the home operator domain name is the string “ims.” appended with the domain portion of the non-IMSI SUPI (e.g., the domain portion of the NAI in embodiments in which the non-IMSI SUPI is a NAI);
the private user identity (e.g., IMPI) is obtained as follows: the username is the same as the username in the non-IMSI SUPI (e.g., the username in the NAI in embodiments in which the non-IMSI SUPI is a NAI), and the domain portion is identical with the home operator domain name above; and/or
the public user identity (e.g., IMPU) is the string “sip:” appended with a username and domain portion equal to the non-IMSI SUPI derived private user identity above.

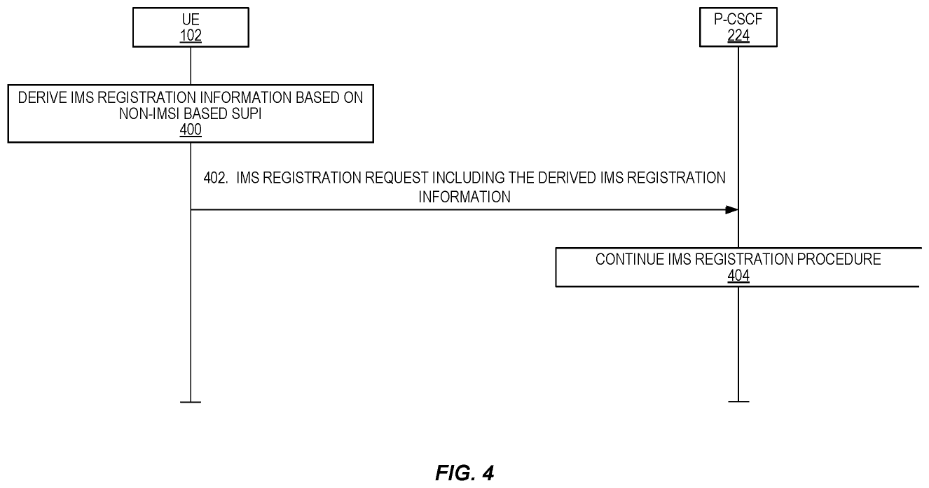

FIG. 4 illustrates an IMS registration procedure in accordance with an embodiment of the present disclosure. As illustrated, the UE 102 derives IMS registration information on a non-IMSI based SUPI of the UE 102 (step 400). The non-IMSI based SUPI is, in one embodiment, a NAI of the UE 102. As discussed above, the IMS registration information includes a home operator domain name, a private identity (e.g., IMPI), and a public identity (e.g., IMPU) for IMS registration. In one embodiment, the UE 102 derives the IMS registration information such that the home operator domain name is the string “ims.” appended with the domain portion of the non-IMSI SUPI (e.g., the domain portion of the NAI in embodiments in which the non-IMSI SUPI is a NAI). In one embodiment, the UE 102 derives the IMS registration information such that the private user identity (e.g., IMPI) is obtained as follows: the username is the same as the username in the non-IMSI SUPI (e.g., the username in the NAI in embodiments in which the non-IMSI SUPI is a NAI), and the domain portion is identical with the home operator domain name above. In one embodiment, the UE 102 derives the IMS registration information such that the public user identity (e.g., IMPU) is the string “sip:” appended with a username and domain portion equal to the non-IMSI SUPI derived private user identity above. Note that while the home operator domain name, the private user identity, and the public user identity are all derived based on the non-IMSI based SUPI, the present disclosure is not limited thereto.

The UE 102 initiates an IMS registration using the derived IMS registration information. In particular, the UE 102 sends an IMS registration request including the derived IMS registration information towards the P-CSCF 224 (step 402). The IMS registration request may also include an IP address of the UE 102. The P-CSCF 224 then continues IMS registration procedure (step 404). The IMS registration procedure itself is well-known and not the subject of the instant disclosure. As such, the remaining details of the IMS registration procedure are not included. For more information, the interested reader is directed to TS 24.229 (see, e.g., V16.6.0).

Below, text corresponding to a 3GPP Change Request (CR) that provides the Stage 2 modifications to 3GPP TS 23.228 V16.4.0 that correspond to one example implementation of an embodiment of the present disclosure. Once the CR is accepted, it will be followed by Stage 3 CRs (mostly on 3GPP 24.229, and 23.003).

### Start Change

Y.3 Address and identity management concepts
Y.3.1 Deriving IMS identifiers from the USIM
If the UICC does not contain an ISIM application, and the permanent user identity is IMSI then clause E.3.1 applies.
For non-IMSI based SUPI, with or without UICC, and in the absence of an ISIM/IMC, the following shall be supported to derive the Home domain, Private and Public Use Identity for initial IMS registration:
   The Home domain shall consist of the string “ims.” appended with the domain portion of the non-IMSI SUPI NAI
   The Private User Identity is obtained as follows: the username is the same as the username in the non-IMSI SUPI NAI, and the domain portion is identical with the Home domain above.
   The Public User Identity shall consist of the string “sip:” appended with a username and domain portion equal to the non-IMSI SUPI derived Private User Identity,

### End Change

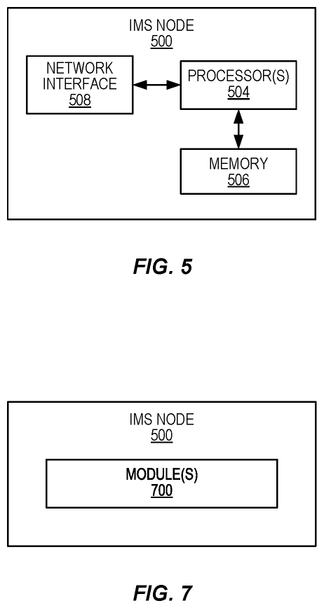

FIG. 5 is a schematic block diagram of an IMS node 500 according to some embodiments of the present disclosure. Optional features are represented by dashed boxes. The IMS node 500 may be, for example, a node that implements all or part of the functionality an IMS entity (e.g., the P-CSCF 224) as described herein. As illustrated, the IMS node 500 includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of the IMS node 500 as described herein. In some embodiments, the function(s) are implemented in software that is stored, e.g., in the memory 506 and executed by the one or more processors 504.

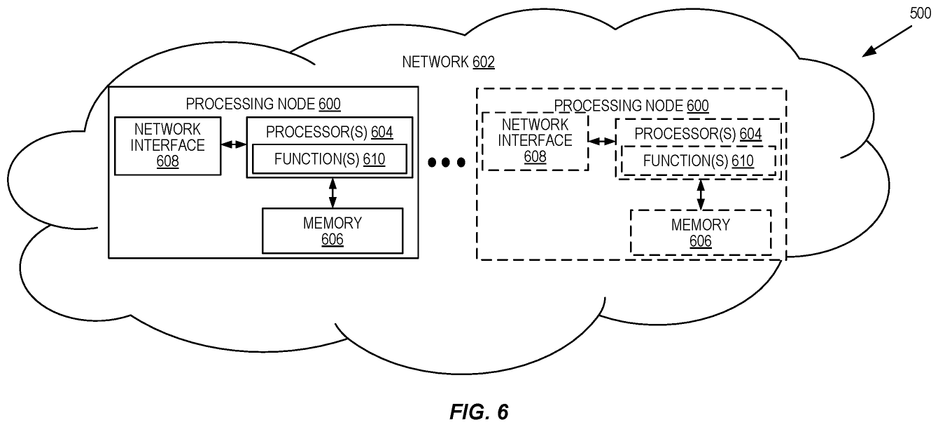

FIG. 6 is a schematic block diagram that illustrates a virtualized embodiment of the IMS node 500 according to some embodiments of the present disclosure. As used herein, a “virtualized” IMS node is an implementation of the IMS node 500 in which at least a portion of the functionality of the IMS node 500 is implemented as a virtual component(s) (e.g., via a virtual machine(s) executing on a physical processing node(s) in a network(s)). As illustrated, the IMS node 500 includes one or more processing nodes 600 coupled to or included as part of a network(s) 602. Each processing node 600 includes one or more processors 604 (e.g., CPUs, ASICs, FPGAs, and/or the like), memory 606, and a network interface 608.

In this example, functions 610 of the IMS node 500 described herein are implemented at the one or more processing nodes 600 or distributed across two or more of the processing nodes 600 in any desired manner. In some particular embodiments, some or all of the functions 610 of the IMS node 500 described herein are implemented as virtual components executed by one or more virtual machines implemented in a virtual environment(s) hosted by the processing node(s) 600.

In some embodiments, a computer program including instructions which, when executed by at least one processor, causes the at least one processor to carry out the functionality of the IMS node 500 or a node (e.g., a processing node 600) implementing one or more of the functions 610 of the IMS node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the IMS node 500 according to some other embodiments of the present disclosure. The IMS node 500 includes one or more modules 700, each of which is implemented in software. The module(s) 700 provide the functionality of the IMS node 500 described herein. This discussion is equally applicable to the processing node 600 of FIG. 6 where the modules 700 may be implemented at one of the processing nodes 600 or distributed across multiple processing nodes 600.

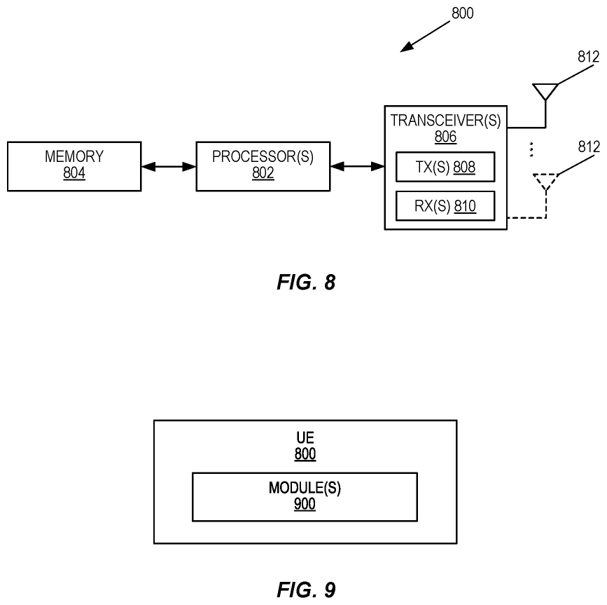

FIG. 8 is a schematic block diagram of a wireless communication device 800 (e.g., the UE 102) according to some embodiments of the present disclosure. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above (e.g., the functionality of the UE 102) may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein (e.g., the functionality of the UE 102) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein (e.g., the functionality of the UE 102).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device for Internet Protocol, IP, Multimedia Subsystem, IMS, registration, the method comprising:
deriving IMS registration information based on a non-International Mobile Subscriber Identity, IMSI, based Subscription Permanent Identifier, SUPI, of the wireless communication device; and
sending an IMS registration request to an IMS node, the IMS registration request comprising the IMS registration information.

2. The method of claim 1 wherein the non-IMSI based SUPI of the wireless communication device is a Network Access Identifier, NAI, of the wireless communication device.

3. The method of claim 1 wherein an Internet Protocol, IP, Multimedia Services Identity Module, ISIM, or IMS Credential, IMC, is not present in the wireless communication device.

4. The method of claim 1 wherein the IMS registration information comprises a private user identity, a public user identity, and a home operator domain name.

5. The method of claim 4 wherein the private user identity is an IP Multimedia Private Identity, IMPI.

6. The method of claim 4 wherein the public user identity is an IP Multimedia Public Identity, IMPU.

7. The method of claim 4 wherein deriving the IMS registration information comprises deriving the IMS registration information such that the home operator domain name is a first string appended with a domain portion of the non-IMSI based SUPI.

8. The method of claim 7 wherein the first string is “ims.”.

9. The method of claim 4 wherein deriving the IMS registration information comprises deriving the IMS registration information such that the private user identity comprises a username and a domain portion, wherein the username is a username comprised in the non-IMSI based SUPI and the domain portion is a first string appended with a domain portion of the non-IMSI based SUPI.

10. The method of claim 9 wherein the first string is “ims.”.

11. The method of claim 4 wherein deriving the IMS registration information comprises deriving the IMS registration information such that the public user identity is a second string appended with a username and a domain portion, wherein the username is a username comprised in the non-IMSI based SUPI and the domain portion is a first string appended with a domain portion of the non-IMSI based SUPI.

12. The method of claim 11 wherein the first string is “ims.” and the second string is “sip:”.

13. The method of claim 1 wherein both an ISIM and IMC are absent at the wireless communication device.

14. The method of claim 1 wherein sending the IMS registration request comprises sending the IMS registration request via a Fifth Generation, 5G, system.

15. (canceled)

16. (canceled)

17. A wireless communication device for Internet Protocol, IP, Multimedia Subsystem, IMS, registration, the wireless communication device comprising:
one or more transmitters; and
processing circuitry associated with the one or more transmitters, the processing circuitry configured to cause the wireless communication device to:
derive IMS registration information based on a non-International Mobile Subscriber Identity, IMSI, based Subscription Permanent Identifier, SUPI, of the wireless communication device; and
send an IMS registration request to an IMS node, the IMS registration request comprising the IMS registration information.

18. A non-transitory computer readable medium storing instructions executable by processing circuitry of a wireless communication device to cause the wireless communication device to:
derive IMS registration information based on a non-International Mobile Subscriber Identity, IMSI, based Subscription Permanent Identifier, SUPI, of the wireless communication device; and
send an IMS registration request to an IMS node, the IMS registration request comprising the IMS registration information.
